(19) United States
(12) Patent Application Publication
(10) Pub. No.: US 2013/0020778 A1
(43) Pub. Date: Jan. 24, 2013

(54) APPARATUS AND METHODS FOR CONNECTING A SHOCK ABSORBER TO A VEHICLE

(71) Applicant: William O. Brown, IV, Aptos, CA (US)

(72) Inventor: William O. Brown, IV, Aptos, CA (US)

(21) Appl. No.: 13/555,936

(22) Filed: Jul. 23, 2012

Related U.S. Application Data
(60) Provisional application No. 61/510,458, filed on Jul. 21, 2011.

(51) Int. Cl. B60G 13/00

(52) U.S. Cl. 280/124.155

(57) ABSTRACT

A shock absorber includes a shock body with an upper portion and a lower portion and an eyelet attached to each upper and lower portion for connecting to a vehicle. At least one eyelet includes a bushing assembly including a center shaft positioned within a bore and a first and second bushing positioned between an outer cylindrical wall of the center shaft and the bore of the eyelet. A first flexible ring is positioned between the first bushing and the center shaft, the first flexible ring compressed therebetween, and a second flexible ring is positioned between the second bushing and the center shaft, the second flexible ring compressed therebetween. A first and second end ring surrounding the center shaft outer cylindrical wall, with the first end ring adjacent the second end of the first bushing, and the second end ring adjacent the second end of the second bushing.

### CROSS-REFERENCE TO RELATED APPLICATIONS

This application claims priority to and benefit of U.S. provisional patent application Ser. No. 61/510,458, filed Jul. 21, 2011, which is herein incorporated by reference.

### BACKGROUND OF THE INVENTION

1. Field of the Invention

The present invention relates to shock absorbers for vehicles. More particularly, the disclosure relates to the connections used to connect shock absorbers to vehicles. More particularly still, the disclosure relates to a bushing assembly.

2. Description of the Related Art

Shock absorbers provide suspension to a bicycle or vehicle and are typically mounted to the vehicle by an eyelet located at a top portion and lower portion of the shock absorber. Fastening means, such as mounting bolts and nuts, are inserted through each shock absorber eyelet and through a corresponding vehicle portion, and fastened so that the shock absorber spans two components of the vehicle. Wheel impact forces are transmitted to the rear shock absorber through the eyelets of the shock absorber. Generally, bushings are positioned within the eyelet and also fastened to the shock absorber at the time the shock absorber is fastened to the vehicle. The bushings assist with absorbing some of the wheel impact forces at the eyelets.

There are problems that arise when using bushings within the eyelets. For example, the tolerance between the eyelet, bushings and mounting bolts may include a medium or transitional fit, and allow for some interplay between the components. This results in a less effective mechanism for absorbing wheel impact forces, and may result in additional vibration to the shock absorber. Additionally, dirt or debris may become trapped between the components, which results in a less effective mechanism for absorbing wheel impact forces, and could degrade the quality of the components.

What is needed is a bushing assembly for an eyelet of a shock absorber that avoids problems associated with the use of bushings.

### SUMMARY OF THE INVENTION

The present invention generally relates to a shock absorber including a shock body with an upper portion and a lower portion and an eyelet attached to each upper and lower portion for connecting to a vehicle. In one embodiment, at least one eyelet includes a bushing assembly comprising a center shaft positioned within a bore of the at least one eyelet, and a first and second bushing positioned between a center shaft outer cylindrical wall and the bore. In one embodiment, a first flexible ring is positioned between the first bushing and the center shaft, the first flexible ring compressed therebetween, and a second flexible ring is positioned between the second bushing and the center shaft, the second flexible ring compressed therebetween. In one embodiment, a first and second end ring surrounding the center shaft outer cylindrical wall, with the first end ring adjacent the second end of the first bushing, and the second end ring adjacent the second end of the second bushing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a bicycle including a rear shock absorber;

FIG. 2 is a perspective view of a rear shock absorber;

FIG. 3 is a cross-section view of a bushing assembly;

FIG. 4 is an exploded view of the bushing assembly as it relates to the rear shock absorber.

### DETAILED DESCRIPTION

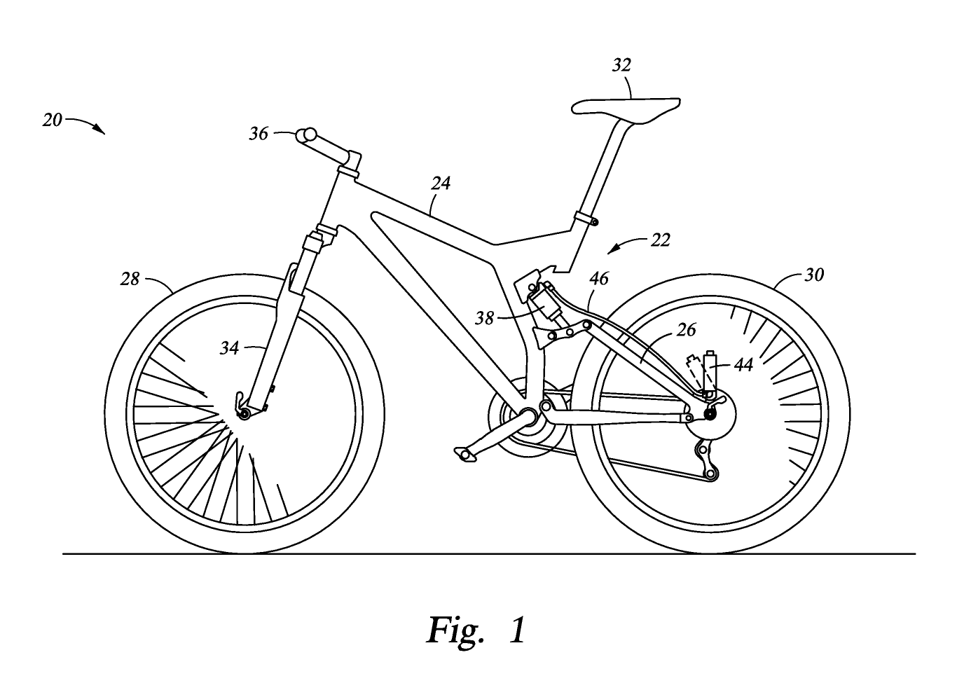

FIG. 1 is a perspective view of a bicycle including a rear shock absorber. FIG. 1 illustrates an off-road bicycle, or mountain bike 20 including a frame 22 which is comprised of a main frame portion 24 and a swing arm portion 26. The swing arm portion 26 is pivotally attached to the main frame portion 24. The bicycle 20 includes front and rear wheels 28, 30 connected to the main frame 24. A seat 32 is connected to the main frame 24 and provides support for a rider of the bicycle 20.

The front wheel 28 is supported by a suspension fork 34, which is secured to the main frame 24 by a handlebar assembly 36. The rear wheel 30 is connected to the swing arm portion 26 of the frame 22. A rear shock absorber 38 is operably positioned between the swing arm 26 and the main frame 24 to provide resistance to the pivoting motion of the swing arm 26. In a preferred embodiment, the rear shock absorber 38 includes a fluid reservoir 44 hydraulically connected to the main shock body by a hydraulic hose 46. Preferably, the reservoir 44 is connected to the swing arm portion 26 of the bicycle above the hub axis of the rear wheel 30. Suspension members 34, 38 between the front and rear wheels 28, 30 and the frame 22 operate to substantially reduce wheel impact forces from being transmitted to the rider of the bicycle 20.

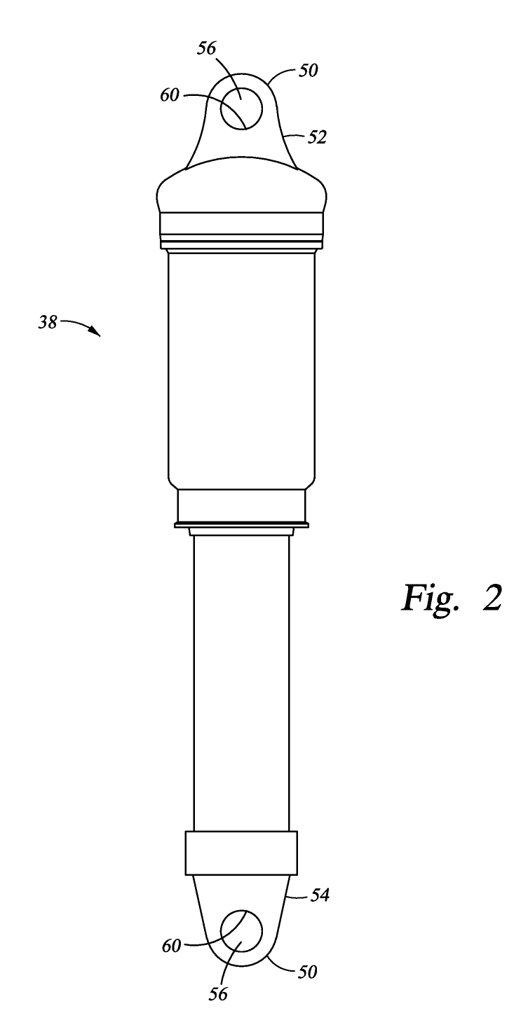

FIG. 2 is a perspective view of a rear shock absorber 38. The rear shock absorber 38 is connected to the swing arm 26 and the main frame 24 (as shown in FIG. 1) by mounting bolts and nuts or other fasteners that extend through an eyelet 50 located at an upper end 52 and a lower end 54 of the shock absorber 38. The wheel impact forces are transmitted to the rear shock absorber 38 through the swing arm 26 and main frame 24 and through the eyelets 50, which cause the upper and lower ends 52, 54 to move toward each other and rebound back to a resting position. Generally, a bushing assembly 60 is positioned at least partially within bores 56 of the eyelets 50 to receive mounting bolts or other fasteners in order to provide an interface that can absorb a portion of the wheel impact forces being transmitted through the eyelets 50.

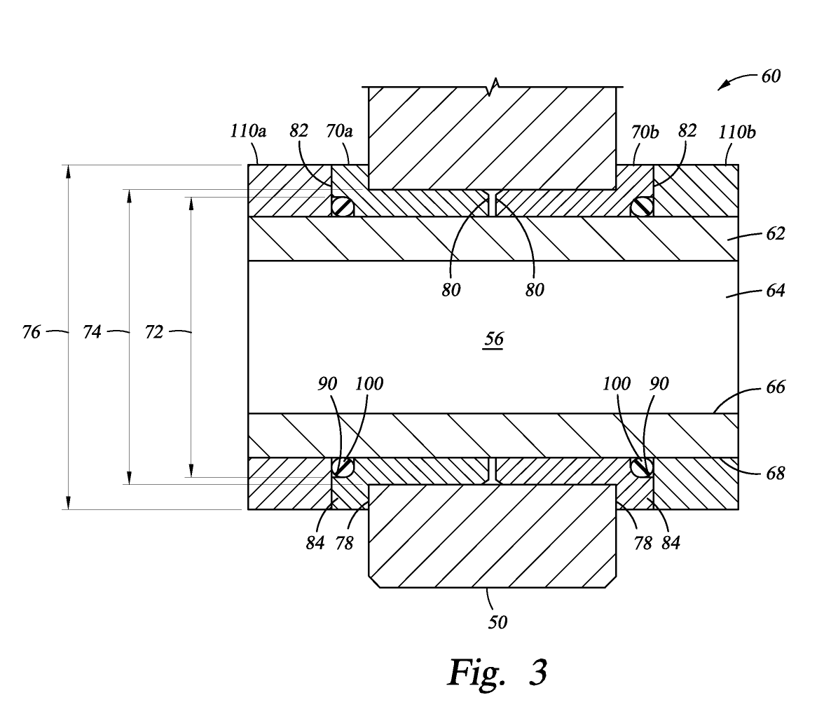

FIG. 3 is a cross-sectional view of an embodiment of the bushing assembly 60. The bushing assembly 60 comprises a center shaft 62 that extends therethrough the bore 56 of the eyelet 50 of the shock absorber 38. The shaft 62 is cylindrical and has a bore 64 that receives the mounting bolt or other fastener. In one embodiment, an inner cylindrical wall 66 forming the bore 64 of the shaft 62 at an inner diameter of the shaft 62 may be smooth, but in another embodiment, the inner cylindrical wall 66 could be at least partially threaded. An outer cylindrical wall 68 at an outer diameter of the shaft 62 may be smooth. The shaft 62 comprises aluminum, steel, titanium, thermoplastic, ceramic or any other suitable material or combination thereof.

The bushing assembly 60 comprises a pair of bushings 70a, b, each including a first end 80 and a second end 82. The bushings 70a, b include an inner diameter that is greater than the outer diameter of the shaft 62, and therefore, the bushings 70a, b may be slidably received over the outer cylindrical wall 68 of the shaft 62. The bushings 70a, b include a first outer diameter 74, wherein the portion of the bushings 70a, b with the first outer diameter 74 may be received, at least partially, within the eyelet 50. Each bushing 70a, b is inserted into the eyelet 50 from opposite openings in the eyelet 50 with the first ends 80 of each bushing 70a, b positioned within the eyelet 50. In one embodiment, the distance between the first end 80 and a flange portion 84 of the bushing 70a, b may be one-half of a width of a bore of the eyelet 60, wherein the flange portion 84 of each bushing 70a, b is shouldered by an outer portion 78 of the eyelet 50. The flange portion 84 provides a second outer diameter 76 to the bushings 70a, b, and aids in absorbing axial stress on the shock absorber 38. The bushings 70a, b may comprise an elastomer, aluminum, steel, titanium, thermoplastic, ceramic, or any other suitable material or combination thereof. The bushings 70a, b may also comprise an elastomer filled with glass, carbon, fibers, beads, microspheres or microtubes, or any other suitable plastic, filler, or suitable combination thereof. The bushings 70a, b may be formed by molding, casting, milling or any other suitable method of manufacture.

In one embodiment, the bushings 70a, b further comprise an inner recess 90 with an inner recess diameter 72 for receiving a flexible ring 100, such as an elastomeric o-ring. The inner recess 90 could include three sides, and therefore fully encapsulate the flexible ring 100 between the bushing 70a, b and the shaft 62. Alternatively, and as shown in FIG. 3, the inner recess 90 could include two sides, wherein a separate component, as will be discussed herein, provides the third side. The flexible ring 100 may comprise nitrile, viton, rubber, or any other suitable material. In one embodiment, the inner recess 90 includes a recess inner diameter 72 such that the recess inner diameter 72 is less than two times a cross sectional thickness of the flexible ring 100. Stated differently, the cross sectional thickness of flexible ring 100 is at least two times greater than the recess inner diameter 72, and therefore, the flexible ring 100 is compressed within the inner recess 90 and provides a radial spring effect, which aids in buffering any tolerance gap between the bushings 70a, b and the shaft 62. In addition, the flexible ring 100 may prevent dirt from moving between the bushing 70a, b and the shaft 62. Alternatively, or in addition, a different spring element could be inserted into the inner recess 90 to provide a similar spring effect. In one embodiment, the recess inner diameter 72 is equivalent to the inner diameter 74 of the bushings 70a, b. In one embodiment, the recess inner diameter 72 is eccentric to the inner diameter 74 of the bushings 70a, b.

In one embodiment an axis of the flexible ring 100 may be centered on the axis of the bushing 70a, b. In such embodiment, an equal pressure around the circumference of the shaft 62 and a net radial force of zero would act on the shaft 62. Alternatively, the axis of the flexible ring 100 may be radially offset from the axis of the bushing 70a, b. In such embodiment, an asymmetric pressure results around the circumference of the shaft 62 and a net radial force results biasing the shaft 62 to one side of the bushing 72a, b. It is contemplated that each bushing 70a, b could include a plurality of recesses 90 and a plurality of flexible rings 100. Further, it is contemplated that the positioning and diameters of each recess could comprise a variety of combinations (eccentric/non-eccentric, along the axis/offset, etc).

The bushing assembly 60 further comprises two end rings 110a, b, which are positioned adjacent to the second end 82 of each bushing 70a, b. The end rings 110a, b include an inner diameter that is less than the outer diameter of the shaft 62, and therefore, the end rings 110a, b may be press fit over the outer cylindrical wall 68 of the shaft 62. The end rings 110a, b also include an outer diameter that is substantially equivalent to the second outer diameter 76 of the bushings 70a, b. The end rings 110a, b comprise aluminum, steel, titanium, thermoplastic, ceramic or any other suitable material or combination thereof.

In one embodiment, a collective length of the two end rings 110a, b and the two bushings 70a, b may be equal to the shaft 62. Accordingly, mounting bolts or other fasteners inserted through the bore 64 of the center shaft 62 may firmly hold the entire bushing assembly 60 in place within the eyelet 50.

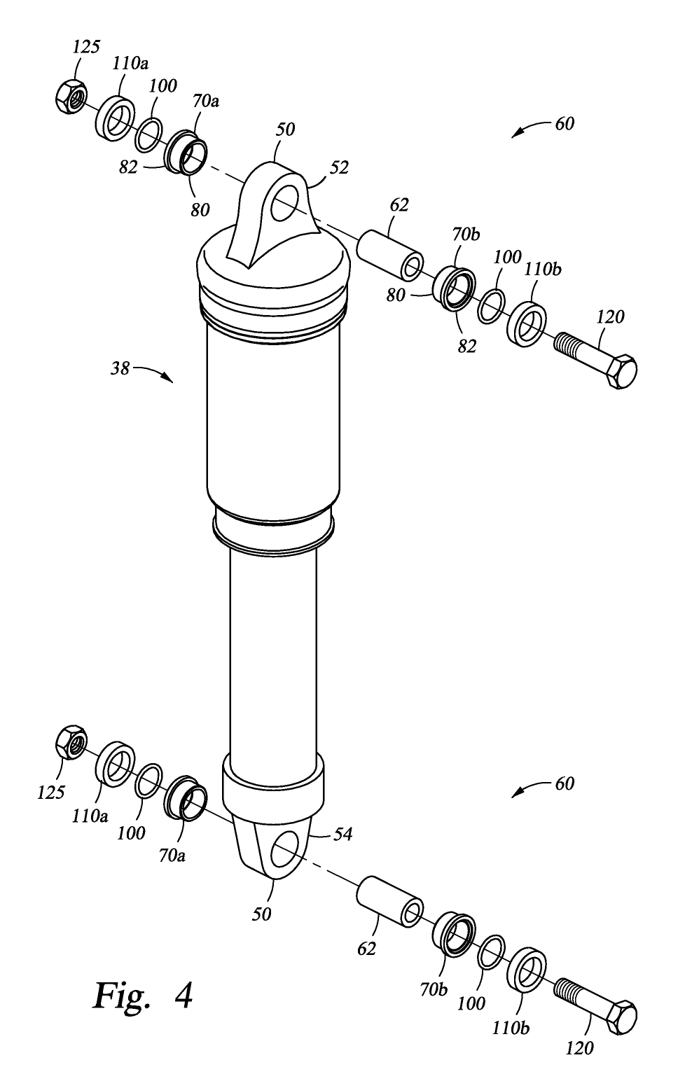

FIG. 4 is an exploded view of the bushing assembly 60 as it relates to the rear shock absorber 38. In one embodiment, the bushing assembly 60 may be used in the eyelets 50 located at both ends 52, 54 of the shock absorber. In another embodiment, the bushing assembly 60 could be used in one of the eyelets 50. To install the bushing assembly 60 within the eyelet in one embodiment, the center shaft 62 is inserted into the bore 56 of the eyelet 50. Two bushings 70a, b are slid over the outer diameter of the shaft 62 with the first end 80 towards the eyelet 50. Conversely, the bushings 70a, b could be inserted into the bore 60 of the eyelet 50 followed by insertion of the shaft 62. The flexible rings 100 slide over the shaft 62 and into the inner recess 90 of each bushing 70a, b. The end rings 110a, b also slide over the shaft 62 and further squeeze the flexible rings 100 into the recess 90 of each bushing 70a, b. Finally, a mounting bolt 120 is slid through the center shaft 62 and secured by a nut 125, with an appropriate amount of torque applied to secure the bolt 120 connection.

The forgoing illustrates an apparatus and method used to obtain better damping at the eyelets 50 of a shock absorber 38. The bushings 70a, b, which may comprise a thermoplastic or other material with a low modulus of elasticity, is well suited for absorbing vibrations, and provides a first damping means when forces are applied at the eyelets 50. The shaft 62, which may comprise a metal or other strong material, provides support to the bushings 70a, b. Further, the flexible ring 100, which is under compression within the recess 90 of each bushing 70a, b provides another mechanism for absorbing vibrations, as it provides a light press fit stress between the bushings 70a, b and the eyelet 50. Accordingly, because the bushing assembly 60 includes several components suitable for absorbing vibrations, the impact forces from the wheels of a bicycle 20 on the shock absorber 38 are decreased by use of the bushing assembly 60.

While the foregoing is directed to embodiments of the present invention, other and further embodiments of the invention may be devised without departing from the basic scope thereof, and the scope thereof is determined by the claims that follow.

What is claimed is:

1. A shock absorber, comprising:
a shock body with an upper portion and a lower portion; and
an eyelet attached to each upper and lower portion for connecting to a vehicle, at least one eyelet including a bushing assembly comprising:
a center shaft positioned within a bore of the eyelet,
a first and second bushing positioned between a center shaft outer cylindrical wall and the bore,
a first flexible ring positioned between the first bushing and the center shaft, the first flexible ring compressed therebetween,
a second flexible ring positioned between the second bushing and the center shaft, the second flexible ring compressed therebetween, and
a first and second end ring surrounding the center shaft outer cylindrical wall, the first end ring adjacent the first bushing, and the second end ring adjacent the second bushing.

2. The shock absorber of claim 1, wherein the center shaft is constructed of metal.

3. The shock absorber of claim 1, wherein the bushings are constructed of thermoplastic.

4. The shock absorber of claim 1, wherein the flexible rings are elastomeric o-rings.

5. The shock absorber of claim 1, wherein the first bushing includes a first recess for receiving the first flexible ring and the second bushing includes a second recess for receiving the second flexible ring.

6. The shock absorber of claim 5, wherein an inner diameter of the first and second recesses are less than two times a cross sectional thickness of the first and second flexible rings.

7. The shock absorber of claim 5, wherein an inner diameter of the first and second recesses is eccentric to a first outer diameter of the first and second bushings.

8. The shock absorber of claim 1, wherein an axis of the first flexible ring is aligned with an axis of the first bushing and an axis of the second flexible ring is aligned with an axis of the second bushing.

9. The shock absorber of claim of claim 1, wherein an axis of the first flexible ring is asymmetric with an axis of the first bushing and an axis of the second flexible ring is asymmetric with an axis of the second bushing.

10. The shock absorber of claim 1, wherein a plurality of flexible rings are positioned between each of the first and second bushings and the center shaft.

11. The shock absorber of claim 1, wherein each bushing has a first outer diameter and a second outer diameter, and a portion of each bushing with the first outer diameter is at least partially positioned within the bore, and a portion of each bushing with the second outer diameter is positioned outside of the bore.

12. A bushing assembly for use in an eyelet of a shock absorber, comprising:
a center shaft;
a first and second bushing positioned on an outer cylindrical wall of the center shaft, the first and second bushings each having a first end and a second end, the first ends of the first and second bushings adjacent one another,
a first flexible ring for compression between the first bushing and the center shaft;
a second flexible ring for compression between the second bushing and the center shaft; and
a first and second end ring surrounding the outer cylindrical wall of the center shaft, the first end ring adjacent the second end of the first bushing, and the second end ring adjacent the second end of the second bushing.

13. The shock absorber of claim 12, wherein the first bushing includes a first recess for receiving the first flexible ring and the second bushing includes a second recess for receiving the second flexible ring.

14. The shock absorber of claim 13, wherein an inner diameter of the first and second recesses are less than two times a cross sectional thickness of the first and second flexible rings.

15. The shock absorber of claim 13, wherein an inner diameter of the first and second recesses is eccentric to a first outer diameter of the first and second bushings.

16. The shock absorber of claim 12, wherein the first and second recess each have two sides for surrounding the first and second flexible rings.

17. The shock absorber of claim 16, wherein the first and second end rings provide a third side for surrounding the first and second flexible rings.

18. The shock absorber of claim 12, wherein the first and second recess have three sides for surrounding the first and second elements.

19. A shock absorber, comprising:
a shock body with an upper portion and a lower portion; and
an eyelet attached to each upper and lower portion for connecting to a vehicle, at least one eyelet including a bushing assembly comprising:
a center shaft positioned within a bore of the at least one eyelet,
a first and second bushing positioned between a center shaft outer cylindrical wall and the bore,
a first flexible ring positioned in a first recess between the first bushing and the center shaft and under compression,
a second flexible ring positioned in a second recess between the second bushing and the center shaft and under compression, and
a first and second end ring surrounding the center shaft outer cylindrical wall, the first end ring adjacent the first bushing, and the second end ring adjacent the second bushing.

20. The shock absorber of claim 19, wherein the first and second flexible rings are elastomeric o-rings with cross sectional diameters that are at least two times larger than a diameter of the first and second recesses.
